(19) United States
(12) Patent Application Publication
(10) Pub. No.: US 2021/0135377 A1
(43) Pub. Date: May 6, 2021

(54) COMMUNICATION CONTROL DEVICE, COMMUNICATION TERMINAL, AND METHOD FOR CONTROLLING COMMUNICATION TERMINAL

(71) Applicant: SHARP KABUSHIKI KAISHA, Sakai City, Osaka (JP)

(72) Inventor: EITAROH AKASHI, Sakai City, Osaka (JP)

(21) Appl. No.: 16/622,169

(22) PCT Filed: Mar. 27, 2018
(86) PCT No.: PCT/JP2018/012563

§ 371 Date: Dec. 12, 2019

(30) Foreign Application Priority Data
Jun. 13, 2017 (JP) 2017-116203

(51) Int. Cl. H01Q 21/28; H01Q 1/24; H01Q 3/24; H04W 52/30; H04B 1/04

(52) U.S. Cl. CPC H01Q 21/28; H01Q 1/246; H04B 1/04; H04W 52/30; H01Q 3/24

(57) ABSTRACT

A communication control device of a communication terminal that includes a plurality of antennas and performs communication by using a plurality of bands at a same time so that a total sum of maximum transmission power of the plurality of antennas falls within a specified value includes: a use antenna decision unit that decides one or more antennas used for communication in accordance with a use band; and a transmission power decision unit that decides maximum transmission power for each of the use antennas in accordance with a position of the antenna and an antenna characteristic.

### TECHNICAL FIELD

The present invention relates to a communication terminal that performs communication with the outside by using wireless communication and a communication control device provided in the communication terminal.

### BACKGROUND ART

Various researches and evaluations have been conducted for an influence of a radio wave transmitted by a communication terminal using wireless communication on a human body. For example, it has been requested that, by using an SAR (Specific Absorption Rate) for evaluating the degree of the influence of the radio wave on the human body, the communication terminal is configured to satisfy a standard value of the SAR. The SAR indicates an amount of energy absorbed per unit of mass of tissues per unit time. For example, the communication terminal using wireless communication, such as a mobile phone or a smartphone, is required to have the SAR not exceeding the standard value by considering that the communication terminal is used in a state of being proximate to a head of a human body during speaking or the like. Thus, a technique that does not allow the SAR to exceed the standard value is disclosed. For example, PTL 1 describes a wireless communication terminal device in which, in a case of performing communication in parallel by using a plurality of communication systems, in order for the SAR not to exceed the standard value, SARs (specific absorption rates) by the plurality of communication systems are obtained on the basis of transmission power in the respective communication systems, and when a total sum thereof exceeds a standard value, transmission power of communication by any of the communication systems is lowered.

### CITATION LIST

### Patent Literature

PTL 1: Japanese Unexamined Patent Application Publication No. 2013-143574 (published on Jul. 22, 2013)

### SUMMARY OF INVENTION

### Technical Problem

However, PTL 1 does not disclose a specific method by which a communication terminal using carrier aggregation in which communication is performed by using a plurality of bandwidths at the same time by one communication system has different transmission power for each of the bandwidths. Further, a configuration in which, when the communication terminal is configured to have a plurality of antennas at a plurality of positions, transmission power is lowered on the basis of information about the plurality of antennas is not disclosed. Thus, there is a problem that the communication terminal that has the plurality of antennas and uses the carrier aggregation is difficult to have different transmission power for each of the bandwidths used for communication and each of the antennas used for communication.

### Solution to Problem

In order to solve the aforementioned problem, a communication control device according to an aspect of the invention is a communication control device of a communication terminal, the communication terminal including a plurality of antennas and performing communication by a communication system by which communication is performed by using a plurality of bands at a same time and by which a total sum of maximum transmission power of the plurality of antennas falls within a specified value. The communication control device includes a use antenna decision unit that decides one or more antennas used for communication from among the plurality of antennas in accordance with a use band, and a transmission power decision unit that, in a case where a plurality of antennas are used, decides maximum transmission power for each of the use antennas in accordance with a position-characteristic relationship that is a relationship between a position of the antenna in the communication terminal and an antenna characteristic of the antenna.

In order to solve the aforementioned problem, a method for controlling a communication terminal according to an aspect of the invention is a method for controlling a communication terminal that includes a plurality of antennas and performs communication by a communication system by which communication is performed by using a plurality of bands at a same time and by which a total sum of maximum transmission power of the plurality of antennas falls within a specified value. The method includes a use antenna decision step of deciding one or more antennas used for communication from among the plurality of antennas in accordance with a use band, and a transmission power decision step of, in a case where a plurality of antennas are used, deciding maximum transmission power for each of the use antennas in accordance with a position-characteristic relationship that is a relationship between a position of the antenna in the communication terminal and an antenna characteristic of the antenna.

### Advantageous Effects of Invention

The aforementioned configuration has the advantage of providing a communication control device that takes an antenna characteristic into account and is excellent in usability.

### BRIEF DESCRIPTION OF DRAWINGS

FIG. 1 is a block diagram illustrating an example of a configuration of a main part of a smartphone according to Embodiment 1 of the invention.

FIG. 2 is a schematic view illustrating an example of a positional relationship of antennas in the smartphone according to Embodiment 1 of the invention.

FIG. 3 is a schematic view illustrating an example of a data structure of a maximum transmission power table that the smartphone according to Embodiment 1 of the invention has.

FIG. 4 is a flowchart illustrating an example of a flow of processing performed by the smartphone according to Embodiment 1 of the invention.

FIG. 5 is a block diagram illustrating an example of a configuration of a main part of a smartphone according to Embodiment 2 of the invention.

FIG. 6 is a schematic view illustrating an example of a positional relationship of antennas in the smartphone according to Embodiment 2 of the invention.

FIG. 7 is a schematic view illustrating an example of a data structure of a maximum transmission power table that the smartphone according to Embodiment 2 of the invention has.

FIG. 8 is a block diagram illustrating an example of a configuration of a main part of a smartphone according to Embodiment 3 of the invention.

FIG. 9 is a schematic view illustrating an example of a data structure of a maximum transmission power table that the smartphone according to Embodiment 3 of the invention has.

### DESCRIPTION OF EMBODIMENTS

### Embodiment 1

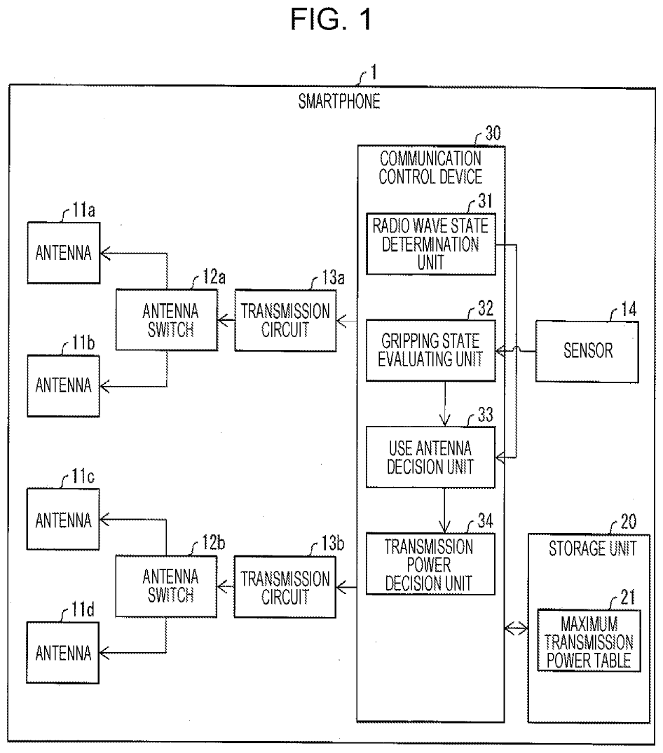

A smartphone (communication terminal) 1 according to Embodiment 1 of the invention will be described below with reference to FIGS. 1 to 4.

### (Configuration of Smartphone)

A configuration of the smartphone 1 according to the present embodiment will be described with reference to FIG. 1. FIG. 1 is a block diagram illustrating an example of a configuration of a main part of the smartphone 1.

The smartphone 1 includes antennas 11a to 11d, antenna switches 12a and 12b, transmission circuits 13a and 13b, a sensor 14, a storage unit 20, and a communication control device 30. The storage unit 20 includes at least a maximum transmission power table 21, and the communication control device 30 includes a radio wave state determination unit 31, a gripping state evaluating unit 32, a use antenna decision unit 33, and a transmission power decision unit 34.

The smartphone 1 is a communication terminal capable of performing communication by so-called carrier aggregation in which communication is performed by using a plurality of bands at the same time. Moreover, the smartphone 1 is able to perform communication so that a total sum of maximum transmission power in the plurality of antennas 11a to 11d falls within a specified value. In a case where the smartphone 1 performs communication by using the LTE (Long Term Evolution), for example, a value specified by the 3GPP (Third Generation Partnership Project) is applied to the specified value. Further, though not illustrated in FIG. 1, the smartphone 1 has a configuration to receive data from the outside and perform processing for the received data. For example, the smartphone 1 may further include a not-illustrated receiver or a not-illustrated control unit which performs processing on the basis of the received data. Note that, the communication terminal may not be a smartphone as long as including a plurality of antennas, enabling to perform communication by using a plurality of bands at the same time, and further enabling to perform communication so that a total sum of maximum transmission power of the plurality of antennas falls within a specified value. For example, the communication terminal may be a mobile phone, a tablet, a PC, or the like.

The antennas 11a to 11d are connected to any of the antenna switch 12a and the antenna switch 12b. According to the example illustrated in the figure, the antennas 11a and 11b are connected to the antenna switch 12a and the antenna 11c and the antenna 11d are connected to the antenna switch 12b. Each of the antennas is able to switch between a transmission enabled state and a pause state when being switched by an antenna switch connected to the antenna. Moreover, each of the antennas is able to transmit data, which is received through an antenna switch connected to the antenna, to the outside as a radio wave. Note that, maximum power (hereinafter, maximum transmission power) used for transmission of the radio wave is decided in advance in the communication control device 30.

The antenna switches 12a and 12b are connected to at least any of the antennas 11a to 11d and further connected to any of the transmission circuit 13a and the transmission circuit 13b. According to the example illustrated in the figure, the antenna switch 12a is connected to the antenna 11a and the antenna 11b and to the transmission circuit 13a, and the antenna switch 12b is connected to the antenna 11c and the antenna 11d and to the transmission circuit 13b. The antenna switches 12a and 12b receive information directly received from the communication control device 30 or information from the communication control device 30 via any of the transmission circuit 13a and the transmission circuit 13b connected to the antenna switches 12a and 12b. Then, the antenna switches 12a and 12b are able to switch an antenna used for transmission of the radio wave on the basis of the received information.

The transmission circuits 13a and 13b are able to transmit the information, which is received from the communication control device 30, via the antenna switch 12a and the antenna switch 12b to the antennas 11a to 11d. Each of the transmission circuit 13a and the transmission circuit 13b is able to transmit the information, which is to be transmitted, by using a specific band designated by the communication control device 30 from among a plurality of bands that are able to be set by each of the transmission circuit 13a and the transmission circuit 13b. Note that, in the following description, it is assumed that the transmission circuit 13a is able to use N types (N is any integer) of bands of a BandA1 to a BandAN and the transmission circuit 13b is able to use M types (M is any integer) of bands of a BandB1 to a BandBM.

The sensor 14 is a sensor that acquires a gripping state of the smartphone 1 and may be constituted by, for example, an acceleration sensor capable of detecting a direction of the smartphone 1 in a three-dimensional space. The sensor 14 is able to transmit information about a measurement result to the gripping state evaluating unit 32.

The storage unit 20 stores various kinds of information handled in the smartphone 1. In the present embodiment, the storage unit 20 includes at least the maximum transmission power table 21.

The maximum transmission power table 21 is a table that is referred to and updated by the communication control device 30. More specifically, the maximum transmission power table 21 is a table that includes at least antenna identification information for identifying an antenna used for communication, a communication band used for communication by the antenna, and maximum transmission power when communication is performed with the communication band by the antenna. Details of the maximum transmission power table 21 will be described later.

The communication control device 30 is a device that integrally controls the respective units of the smartphone 1. By using a receiver that is not illustrated, the communication control device 30 is able to receive, from an external base station, information about a band used for communication with the base station. On the basis of a radio wave state with respect to the base station and the gripping state of the smartphone 1, the communication control device 30 is able to decide a combination of an antenna used for communication, a band of a radio wave used for communication, and maximum transmission power of the radio wave. The communication control device 30 is also able to transmit information as the radio wave by using the decided antenna.

The radio wave state determination unit 31 is able to determine a radio wave state that is a communication state by the radio wave between the smartphone 1 and the base station. The radio wave state determination unit 31 is able to transmit a determination result to the use antenna decision unit 33. The radio wave state determination unit 31 may have any configuration as long as enabling to determine the radio wave state with respect to the base station. For example, the radio wave state may be determined on the basis of radio wave intensity when the radio wave from the base station is received by the receiver that is not illustrated.

When receiving the measurement result from the sensor 14, the gripping state evaluating unit 32 is able to evaluate the gripping state of the smartphone 1 by a user on the basis of the received measurement result. The gripping state evaluating unit 32 is able to transmit an evaluation result to the use antenna decision unit 33.

The use antenna decision unit 33 decides a combination of an antenna used for communication and a use band on the basis of the information about the band used for communication, which is received from the external base station, the determination result related to the radio wave state, which is received from the radio wave state determination unit 31, and the evaluation result related to the gripping state, which is received from the gripping state evaluating unit 32. That is, the use antenna decision unit 33 is able to decide one or more antennas used for communication from among the plurality of antennas 11a to 11d in accordance with the band used for communication. The use antenna decision unit 33 is able to transmit a decided content to the transmission power decision unit 34. Further, the use antenna decision unit 33 may have a configuration enabling to switch the antennas used for communication, for example, on the basis of an instruction to change the band used for communication from the base station, and a change in an external environment of the smartphone 1 due to movement of the user or the like.

On the basis of the information received from the use antenna decision unit 33 or the like, the transmission power decision unit 34 is able to decide maximum transmission power for each of the antennas used for communication. More specifically, when the use antenna decision unit 33 decides to use a plurality of antennas for communication, the transmission power decision unit 34 is able to decide maximum transmission power for each of the use antennas by using a position-characteristic relationship that is a relationship between a position of the antenna in the smartphone 1 and an antenna characteristic of the antenna. The antenna characteristic indicates a property for characterizing each of the antennas and an example thereof includes a ratio (antenna efficiency) of magnitude of radiant power to magnitude of transmission power. Moreover, when the use antenna decision unit 33 decides to switch the antennas used for communication, the transmission power decision unit 34 is able to decide again maximum transmission power for each of antennas that are switched on.

### (Method for Deciding Antenna Used for Communication)

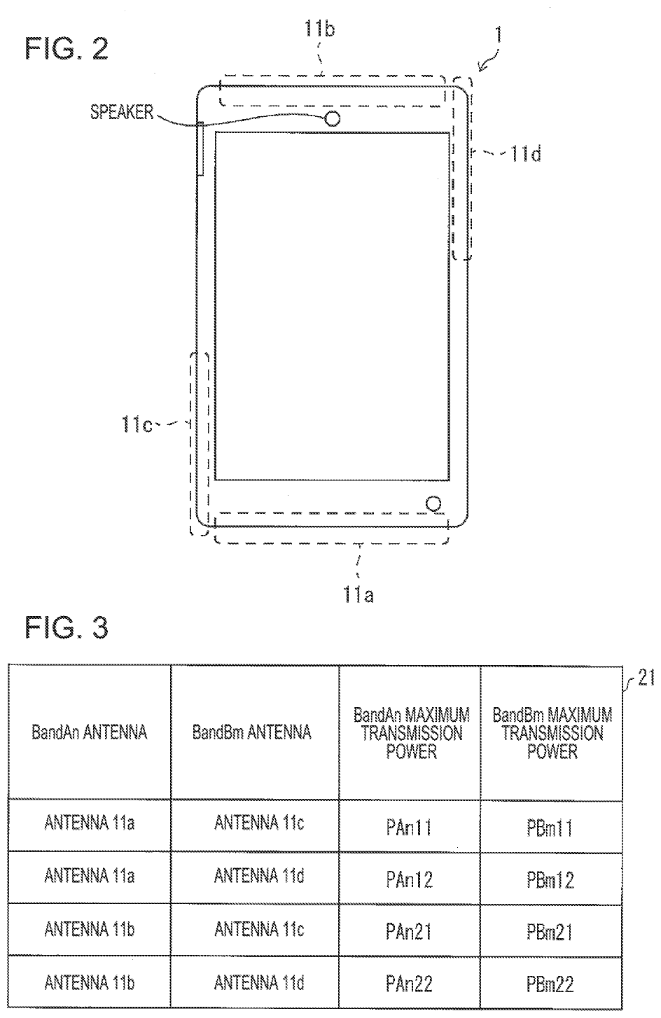

A method for deciding an antenna, which is used for communication, by the use antenna decision unit 33 in the smartphone 1 according to the present embodiment will be described with reference to FIG. 2. FIG. 2 is a schematic view illustrating an example of a positional relationship of antennas in the smartphone 1.

Here, as illustrated in FIG. 2, it is assumed that, in a housing of the smartphone 1, the antennas 11a to 11d are arranged by being dispersed and a speaker (receiver) is further arranged near the antenna 11b and the antenna 11d. At this time, for example, in a case where the user speaks by using the smartphone 1, the user is considered to grip the smartphone 1 so that a region including the speaker is close to an ear of the user in order to hear sound output from the speaker. In such a case, the antenna 11b and the antenna 11d are arranged to be closer to a head including the ear of the user than the antenna 11a and the antenna 11c are arranged. Thus, when the radio wave is transmitted from the antenna 11b and the antenna 11d that are arranged near the speaker, an amount of the radio wave absorbed by the head of the user is greater than an amount of the radio wave absorbed when the radio wave is transmitted from the antenna 11a and the antenna 11c. Thus, in a case where the user speaks by griping the smartphone 1, communication is preferably performed by transmitting the radio wave from the antenna 11a and the antenna 11c. Moreover, whether to use the antenna 11a or the antenna 11c for communication may be decided, for example, on the basis of whether or not communication using a band instructed by the base station is allowed or may be decided on the basis of the determination result related to the radio wave state by the radio wave state determination unit 31.

In this manner, the use antenna decision unit 33 is able to decide the antenna used for communication. Note that, it is suitable that the result evaluated by the gripping state evaluating unit 32 from a detection result of the sensor 14 is used for the gripping state of the smartphone 1 and the determination result of the radio wave state determination unit 31 is used for a communication state with respect to the base station.

### (Combination of Use Antenna and Maximum Transmission Power)

A combination of maximum transmission power for each of antennas, which is decided by the transmission power decision unit 34 in the smartphone 1 according to the present embodiment, will be described with reference to FIG. 3. FIG. 3 is a schematic view illustrating an example of a data structure of the maximum transmission power table 21 that the smartphone 1 has. In the example illustrated in the figure, the maximum transmission power table 21 has a configuration in which a combination of antenna identification information for identifying an antenna and maximum transmission power when communication is performed by the antenna is constructed for each communication band. Note that, the maximum transmission power table 21 may have any data structure as long as having a configuration in which maximum transmission power is able to be decided for each of a plurality of antennas decided from a communication band used for communication.

In the following description, a case where communication is performed by using two of four antennas of the antennas 11a to 11d will be described. Note that, the number of antennas used for communication in the smartphone 1 according to the present embodiment is not required to be always two, and only one antenna may be used for communication or three or more antennas may be used for communication, for example.

Moreover, it is assumed that two of a BandAn (n is any integer of 1 to N) and a BandBm (m is any integer of 1 to M) are designated as use bands by the base station.

In the example illustrated in the figure, an item name “BandAn antenna” indicates an antenna that performs communication by using the band BandAn. According to FIG. 1, since antennas connected to the transmission circuit 13a are the antennas 11a and 11b, any of them is selected. Similarly, an item name “BandBm antenna” indicates an antenna that performs communication by using the band BandBm. According to FIG. 1, any of the antennas 11c and 11d is selected.

An item name “BandAn maximum transmission power” indicates a maximum value of transmission power used for communication in the antenna designated in the item name “BandAn antenna”. Similarly, an item name “BandBm maximum transmission power” indicates a maximum value of transmission power used for communication in the antenna designated in the item name “BandBm antenna”.

For example, a record in a first line of FIG. 3 indicates that, when the “BandAn antenna” is the antenna 11a and the “BandBm antenna” is the antenna 11c, values of maximum transmission power used for communication in the antenna 11a and the antenna 11c are respectively PAn11 and PBm11. Similarly, a record in a second line of FIG. 3 indicates that, when the “BandAn antenna” is the antenna 11a and the “BandBm antenna” is the antenna 11d, values of maximum transmission power used for communication in the antenna 11a and the antenna 11d are respectively PAn12 and PBm12.

In a case where the antennas 11a to 11d have the positional relationship illustrated in FIG. 2 and the user speaks by using the smartphone 1, the antennas 11a and 11c are positioned to be farther from the head of the user than the antennas 11b and 11d are positioned. This means that, even when the maximum transmission power used for communication in the antennas 11a and 11c is set to be greater than the maximum transmission power in the antennas 11b and 11d, an amount of the radio wave absorbed by the head of the user is able to be suppressed. More specifically, it means that, in the “BandBm maximum transmission power”, the PBm11 that is the value when the “BandBm antenna” is the antenna 11c is able to be set to be greater than the PBm12 that is the value when the “BandBm antenna” is the antenna 11d. The PAn12 is suitably set to be greater than the PAn11 in accordance with the PBm12 being set to be smaller than the PBm11. Note that, setting may be performed so that a total sum of maximum transmission power of PAn11+PBm11 is equal to a total sum of maximum power of PAn12+PBm12.

Note that, a total sum of maximum transmission power in the antennas used for communication suitably falls within a given specified value. The given specified value is, for example, an upper limit value specified by the 3GPP and is set so as to satisfy a standard value set to the SAR. Further, the given specified value may be set so as to satisfy another standard value for a local SAR or a head SAR in accordance with the radio wave state with respect to the base station and the gripping state of the smartphone 1, even when a combination of antennas used for communication does not change.

### (Flow of Processing)

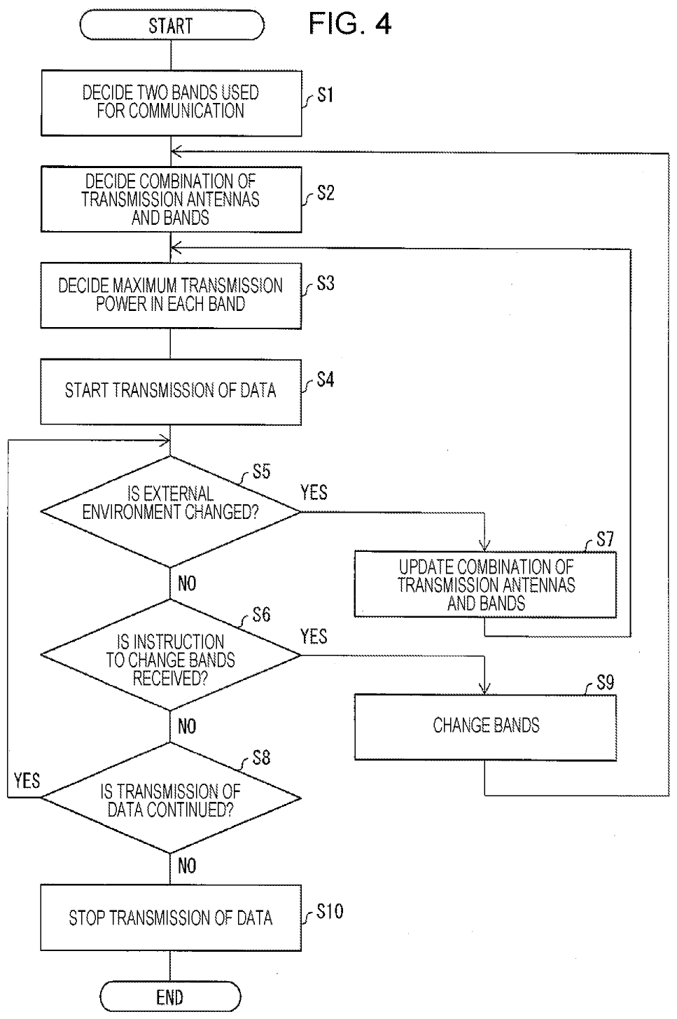

Processing performed by the smartphone 1 according to the present embodiment will be described with reference to FIG. 4. FIG. 4 is a flowchart illustrating an example of the processing performed by the smartphone 1. Note that, in the following description, the smartphone 1 is configured to perform communication by using two bands at the same time, but the number of bands is not limited to two.

First, on the basis of information received from the base station by the receiver that is not illustrated, the communication control device 30 decides two bands used for communication (S1). Next, on the basis of a radio wave state determined by the radio wave state determination unit 31, a gripping state of the smartphone 1, which is evaluated by the gripping state evaluating unit 32, and the two bands decided at step S1, the communication control device 30 decides a combination of antennas and bands used for communication by using the use antenna decision unit 33 (S2: use antenna decision step).

After S2, with respect to the combination of the antennas and the bands decided at S2, the communication control device 30 refers to the maximum transmission power table 21 and decides maximum transmission power in each of the bands by using the transmission power decision unit 34 (S3: transmission power decision step). After that, the communication control device 30 performs switching to the antennas, which are decided to be used for communication at S2, through the antenna switches 12a and 12b and further starts transmission of data from each of the antennas through the transmission circuit 13a and 13b (S4).

After starting the data transmission at S4, the communication control device 30 determines whether or not an external environment of the smartphone 1 is changed (S5). When determining that the external environment is not changed (NO at S5), the communication control device 30 further determines whether or not an instruction to change the bands used for communication is received from the base station (S6). When determining at S5 that the external environment is changed (YES at S5), the communication control device 30 updates the combination of the antennas and the bands used for communication in a similar manner to S2 (S7). Then, the processing proceeds to S3.

When determining at S6 that the instruction to change the bands used for communication is not received from the base station (NO at S6), the communication control device 30 determines whether or not to continue transmission of the data (S8). On the other hand, when determining that the instruction to change the bands is received (YES at S6), the communication control device 30 changes the bands used for transmission of the data in the transmission circuit 13a and the transmission circuit 13b in accordance with the changing instruction (S9). Then, the processing proceeds to S2.

When determining at S8 that transmission of the data is continued (YES at S8), the processing proceeds to S5 to repeat processing of S5 to S8. On the other hand, when determining that transmission of the data is not continued (NO at S8), the communication control device 30 stops transmission of the data (S10) and ends a sequence of processing.

Through the aforementioned processing, the smartphone 1 according to the present embodiment is able to cause the communication control device 30 to decide antennas used for communication in accordance with use bands and further decide maximum transmission power for each of the antennas in accordance with a position-characteristic relationship. Then, communication is able to be performed with maximum transmission power in consideration of an antenna characteristic in each of the antennas. For example, in a case where a specific absorption rate (SAR) is taken into account, the maximum transmission power for each of the antennas is able to be decided so as to lower the SAR. Thus, an effect enabling to provide the communication control device 30 capable of providing carrier aggregation with the SAR lowered and excellent in usability is exerted.

### Embodiment 2

Embodiment 2 of the invention will be described below with reference to FIGS. 4 to 7.

### (Configuration of Smartphone)

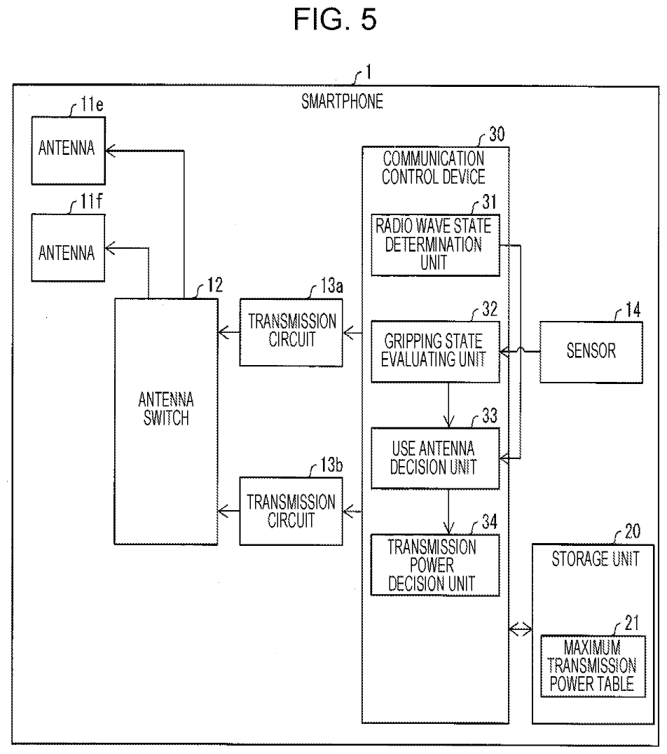

A configuration of the smartphone 1 according to the present embodiment will be described with reference to FIG. 5. FIG. 5 is a block diagram illustrating an example of a configuration of a main part of the smartphone 1.

The smartphone 1 according to the present embodiment is the same as that of Embodiment 1 described above in a basic configuration but is different therefrom in a partial configuration. In the present embodiment, the smartphone includes an antenna switch 12 instead of the antenna switches 12a and 12b, and further, two antennas 11e and 11f are connected to the antenna switch 12.

The antenna switch 12 is the same as the antenna switches 12a and 12b in Embodiment 1 in a basic configuration but is different therefrom in terms of being connected to the transmission circuits 13a and 13b. The antenna switch 12 is able to apply a band (BandAn) selected in the transmission circuit 13a or a band (BandBm) selected in the transmission circuit 13b to any of the antennas 11e and 11f.

The antennas 11e and 11f are the same as the antennas 11a to 11d in Embodiment 1 in a basic configuration but are different therefrom in the following point. The antennas 11e and 11f are able to use both the band (BandAn) selected in the transmission circuit 13a and the band (BandBm) selected in the transmission circuit 13b, under control of the antenna switch 12.

### (Method for Deciding Antenna Used for Communication)

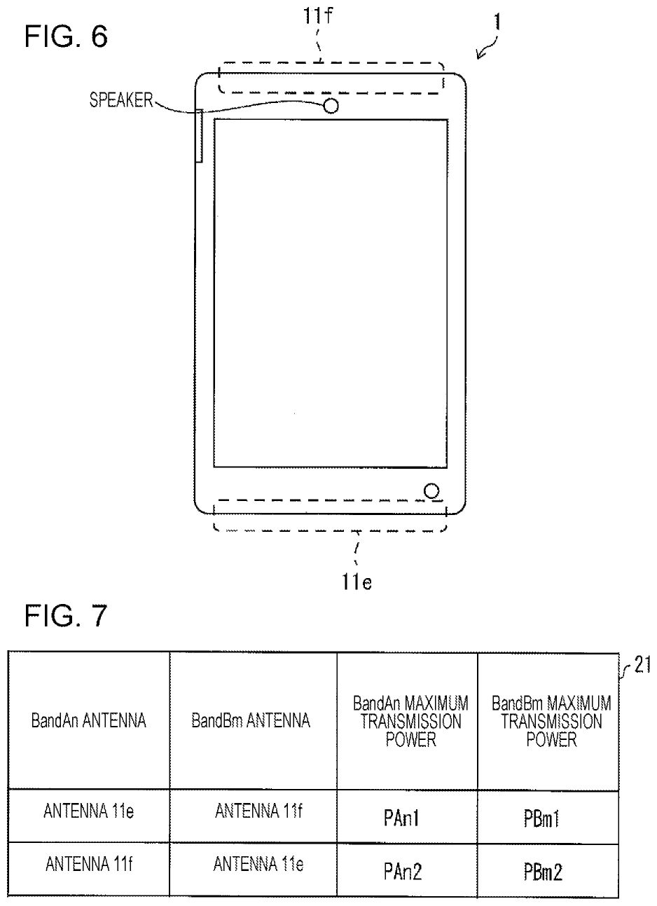

A method for deciding an antenna, which is used for communication, by the use antenna decision unit 33 in the smartphone 1 according to the present embodiment will be described with reference to FIG. 6. FIG. 6 is a schematic view illustrating an example of a positional relationship of antennas in the smartphone 1.

Here, as illustrated in FIG. 6, it is assumed that, in the housing of the smartphone 1, the antennas 11e and 11f are arranged by being dispersed and a speaker (receiver) is further arranged near the antenna 11f. At this time, for example, in a case where the user speaks by using the smartphone 1, the user is considered to grip the smartphone 1 so that a region including the speaker is close to the ear of the user in order to hear sound output from the speaker arranged near the antenna 11f. In such a case, the antenna 11f is arranged to be closer to the head including the ear of the user than the antenna lie is arranged. Thus, communication is preferably performed by using the antenna 11e so that an amount of the radio wave absorbed by the head of the user is reduced while the user speaks, similarly to Embodiment 1 described above.

### (Combination of Use Antenna and Maximum Transmission Power)

A combination of maximum transmission power for each of antennas, which is decided by the transmission power decision unit 34 in the smartphone 1 according to the present embodiment, will be described with reference to FIG. 7. FIG. 7 is a schematic view illustrating an example of a data structure of the maximum transmission power table 21 that the smartphone 1 has. Note that, in the following description, a case where communication is performed by using two antennas of the antennas 11e and 11f will be described. Note that, the number of antennas used for communication in the smartphone 1 according to the present embodiment is not required to be always two, and only one antenna may be used for communication, for example.

It is assumed that precondition is the same as that of Embodiment 1 described above. That is, the transmission circuit 13a is able to use N types of bands of the BandA1 to the BandAN and the transmission circuit 13b is able to use M types of bands of the BandB1 to the BandBM. It is assumed that two of the BandAn (n is any integer of 1 to N) and the BandBm (m is any integer of 1 to M) are designated as use bands by the base station.

According to FIG. 5, the antenna switch 12 is able to apply any of two types of bands of the BandAn and the BandBm to both the antenna 11e and the antenna 11f. At this time, for example, a record in a first line of FIG. 7 indicates that, when the “BandAn antenna” is the antenna 11e and the “BandBm antenna” is the antenna 11f, values of maximum transmission power used for communication in the antenna lie and the antenna 11f are respectively PAn1 and PBm1. Similarly, a record in a second line of FIG. 7 indicates that, when the “BandAn antenna” is the antenna 11f and the “BandBm antenna” is the antenna 11e, values of maximum transmission power used for communication in the antenna lie and the antenna 11f are respectively PAn2 and PBm2.

In a case where the antennas 11e and 11f have the positional relationship illustrated in FIG. 6 and the user speaks by using the smartphone 1, the antenna lie is positioned to be farther from the head of the user than the antenna 11f is positioned. Therefore, the maximum transmission power in the antenna lie is suitably set to be greater than the maximum transmission power in the antenna 11f. That is, in the case of the record in the first line of FIG. 7, the PAn1 that is the value of the “BandAn maximum transmission power” is preferably greater than the PBm1 that is the value of the “BandBm maximum transmission power”. Similarly, in the case of the record in the second line of FIG. 7, the PAn2 that is the value of the “BandAn maximum transmission power” is preferably smaller than the PBm2 that is the value of the “BandBm maximum transmission power”.

Note that, setting is suitably performed so that a total sum of maximum transmission power of PAn1+PBm1 is equal to a total sum of maximum power of PAn2+PBm2.

### (Flow of Processing)

Processing performed by the smartphone 1 according to the present embodiment will be described. Note that, since the flow of the processing in the present embodiment is the same as that in FIG. 4 in Embodiment 1 described above, description will be given with reference to FIG. 4. Note that, in the following description, the smartphone 1 is configured to perform communication by using two bands at the same time, but the number of bands is not limited to two.

As described above, the processing performed by the smartphone 1 in the present embodiment is basically the same as that of Embodiment 1 described above. A difference lies in that the use antenna decision unit 33 decides, at S2, a combination of bands used in the antennas 11e and 11f and that the transmission power decision unit 34 decides, at S3, maximum transmission power by using the maximum transmission power table 21 of FIG. 7.

By the aforementioned processing, the smartphone 1 according to the present embodiment is able to cause the communication control device 30 to perform communication by a band that is able to be set by any of a plurality of transmission circuits to one antenna. This makes it possible to achieve carrier aggregation by a combination of a larger number of bands with a small number of antennas.

### Embodiment 3

Embodiment 3 of the invention will be described below with reference to FIGS. 4, 8, and 9.

### (Configuration of Smartphone)

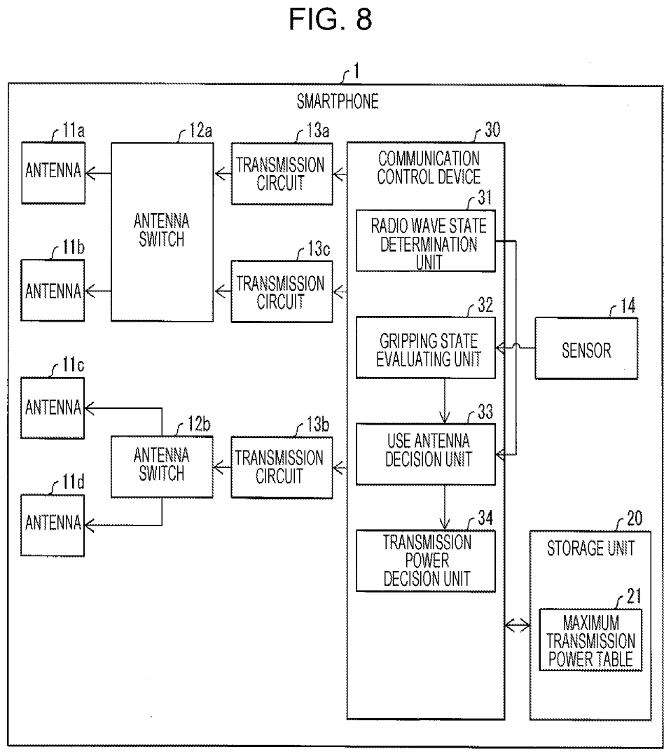

A configuration of the smartphone 1 according to the present embodiment will be described with reference to FIG. 8. FIG. 8 is a block diagram illustrating an example of a configuration of a main part of the smartphone 1.

The smartphone 1 according to the present embodiment is the same as that of Embodiment 1 described above in a basic configuration but is different therefrom in a partial configuration. In the present embodiment, the smartphone 1 further includes a transmission circuit 13c.

The transmission circuit 13c is the same as the transmission circuit 13a according to Embodiments 1 and 2 described above in a basic configuration but is different therefrom in a partial configuration. The transmission circuit 13c is able to use L (L is any integer) types of bands of BandC1 to BandCL.

The antenna switch 12a is the same as that of Embodiment 1 described above in a basic configuration but is different therefrom in terms of being connected to the transmission circuits 13a and 13c. The antenna switch 12a is able to apply a band (BandAn) selected in the transmission circuit 13a or a band (BandCl, l is any integer of 1 to L) selected in the transmission circuit 13c to any of the antennas 11a and 11b.

The maximum transmission power table 21 is the same as that of Embodiment 1 described above in a basic configuration but is different therefrom in terms of being constituted by a combination of tables related to any two transmission circuits of the transmission circuits 13a to 13c. Details of the maximum transmission power table 21 according to the present embodiment will be described later.

### (Method for Deciding Antenna Used for Communication)

A method for deciding an antenna, which is used for communication, by the use antenna decision unit 33 in the smartphone 1 according to the present embodiment is basically the same as that of Embodiment 1 described above except that the antennas 11a and 11b are able to perform communication by using bands set in the transmission circuits 13a and 13c. Since two transmission circuits are connected to the antennas 11a and 11b, communication is able to be performed by using the antenna 11a and the antenna 11b with use of the bands set by the transmission circuit 13a and the transmission circuit 13c, for example.

### (Combination of Use Antenna and Maximum Transmission Power)

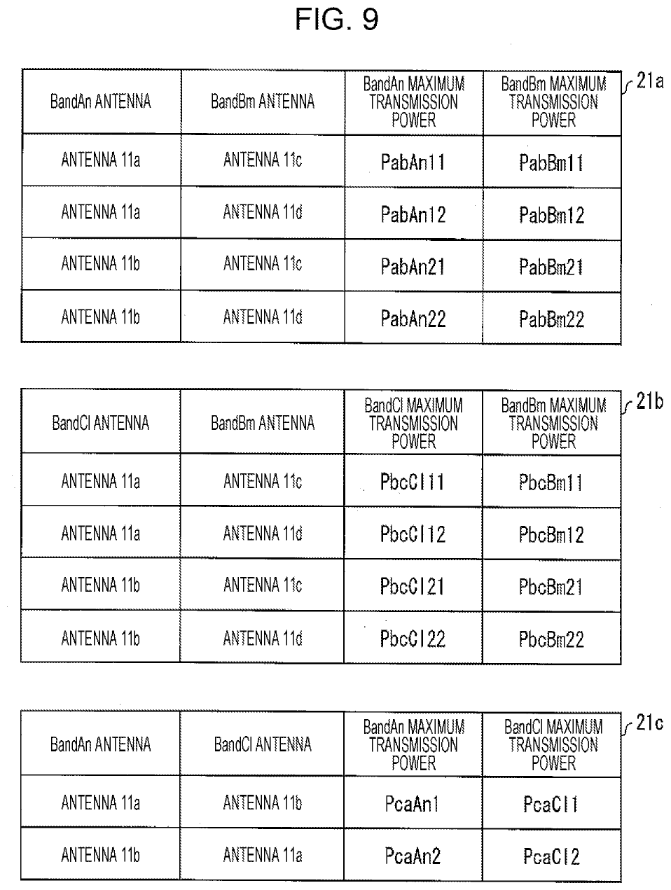

A combination of maximum transmission power for each of antennas, which is decided by the transmission power decision unit 34 in the smartphone 1 according to the present embodiment, will be described with reference to FIG. 9. FIG. 9 is a schematic view illustrating an example of a data structure of the maximum transmission power table 21 that the smartphone 1 has. Note that, in the following description, a case where communication is performed by using two of four antennas of the antennas 11a to 11d will be described. Note that, the number of antennas used for communication in the smartphone 1 according to the present embodiment is not required to be always two, and only one antenna may be used for communication, for example.

In the present embodiment, the maximum transmission power table 21 is constituted by three maximum transmission power tables 21a to 21c. The maximum transmission power table 21a is a table used when communication is performed by using the transmission circuits 13a and 13b. Similarly, the maximum transmission power table 21b is a table used when communication is performed by using the transmission circuits 13c and 13b, and the maximum transmission power table 21c is a table used when communication is performed by using the transmission circuits 13a and 13c.

The maximum transmission power table 21a is almost the same as the maximum transmission power table 21 in Embodiment 1 described above, which is illustrated in FIG. 3. That is, in a combination of the “BandAn antenna” and the “BandBm antenna”, maximum transmission power of each of the antennas is set so that a total sum of the value of the “BandAn maximum transmission power” and the value of the “BandBm maximum transmission power” falls within a given specified value.

The maximum transmission power table 21b is basically the same as the maximum transmission power table 21a in a configuration except for being a table related to a combination of not the “BandAn antenna” but a “BandCl antenna” and the “BandBm antenna”. The maximum transmission power table 21b is used when the communication control device 30 to which the BandCl and the BandBm (m is any integer of 1 to M) are designated as use bands by the base station performs communication by using the transmission circuits 13c and 13b. In a combination of the “BandCl antenna” and the “BandBm antenna”, maximum transmission power of each of the antennas is set so that a total sum of the value of the “BandCl maximum transmission power” and the value of the “BandBm maximum transmission power” falls within a given specified value.

The maximum transmission power table 21c is almost the same as the maximum transmission power table 21 in Embodiment 2 described above, which is illustrated in FIG. 7, except for being a table related to a combination of not the “BandBm antenna” but the “BandCl antenna” and the “BandAn antenna”. That is, in a combination of the “BandAn antenna” and the “BandCl antenna”, maximum transmission power of each of the antennas is set so that a total sum of the value of the “BandAn maximum transmission power” and the value of the “BandCl maximum transmission power” falls within a given specified value.

### (Flow of Processing)

Processing performed by the smartphone 1 according to the present embodiment will be described. Note that, since the flow of the processing in the present embodiment is the same as that in FIG. 4 in Embodiment 1 described above, description will be given with reference to FIG. 4. Note that, in the following description, the smartphone 1 is configured to perform communication by using two bands at the same time, but the number of bands is not limited to two.

The processing performed by the smartphone 1 in the present embodiment is basically the same as those of Embodiments 1 and 2 described above. A difference lies in that the use antenna decision unit 33 decides, at S2, a combination of antennas and bands that are used for communication with respect to two bands including a band that is able to be set by the transmission circuit 13c and that the transmission power decision unit 34 decides, at S3, maximum transmission power by using the maximum transmission power tables 21a to 21c of FIG. 9.

By the aforementioned processing, the smartphone 1 according to the present embodiment is able to cause the communication control device 30 to appropriately select, as needed, carrier aggregation using a plurality of transmission circuits connected to a plurality of mutually different antenna switches and carrier aggregation using a plurality of transmission circuits connected to the same antenna switch.

### [Example of Realization by Software]

Control blocks (particularly, the use antenna decision unit 33 and the transmission power decision unit 34) of the communication control device 30 may be realized by a logic circuit (hardware) formed in an integrated circuit (IC chip) or the like or may be realized by software with use of a CPU (Central Processing Unit).

In the latter case, the communication control device 30 includes a CPU that executes a command of a program that is software enabling each of functions, a ROM (Read Only Memory) or a storage device (each referred to as a “recording medium”) in which the program and various kinds of data are recorded so as to be readable by a computer (or a CPU), a RAM (Random Access Memory) that develops the program, and the like. An object of the invention is achieved by a computer (or a CPU) reading and executing the program from the recording medium. As the recording medium, for example, a “non-transitory tangible medium” such as a tape, a disk, a card, a semiconductor memory, or a programmable logic circuit is able to be used. The program may be supplied to the computer via any transmission medium (such as a communication network or a broadcast wave) which allows the program to be transmitted. Note that, an aspect of the invention can also be achieved in a form of a data signal in which the program is embodied through electronic transmission and which is embedded in a carrier wave.

### CONCLUSION

A communication control device (30) according to an aspect 1 of the invention is a communication control device of a communication terminal (smartphone 1), the communication terminal including a plurality of antennas (11a to 11f) and performing communication by a communication system by which communication is performed by using a plurality of bands at a same time and by which a total sum of maximum transmission power of the plurality of antennas falls within a specified value, and includes: a use antenna decision unit (33) that decides one or more antennas used for communication from among the plurality of antennas in accordance with a use band; and a transmission power decision unit (34) that, in a case where a plurality of antennas are used, decides maximum transmission power for each of the use antennas in accordance with a position-characteristic relationship that is a relationship between a position of the antenna in the communication terminal and an antenna characteristic of the antenna.

According to the aforementioned configuration, the communication control device is able to decide maximum transmission power for each of the antennas by using a relationship between a position of the antenna and an antenna characteristic, so that communication is able to be performed with maximum transmission power in consideration of an antenna characteristic in each of the antennas. For example, in a case where a specific absorption rate (SAR) is taken into account as the antenna characteristic, the maximum transmission power for each of the antennas is able to be decided so as to lower the SAR. This provides the advantage of providing the communication control device capable of lowering the SAR and excellent in usability.

The communication control device (30) according to an aspect 2 of the invention may have a configuration in which the position-characteristic relationship is defined on a basis of a positional relationship between a user and the antenna (antennas 11a to 11f) when the communication terminal (smartphone 1) is used, in the aspect 1.

According to the aforementioned configuration, the communication control device is able to decide maximum transmission power for each of the antennas by using a position-characteristic relationship defined on the basis of the positional relationship between the user and the antenna during usage. Thus, it is possible to decide the maximum transmission power by considering an influence on the user during usage for each of positions of the antennas.

The communication control device (30) according to an aspect 3 of the invention may have a configuration in which the transmission power decision unit (34) causes maximum transmission power of an antenna that is proximate to the user when the communication terminal (smartphone 1) is used among the plurality of antennas (11a to 11f) to be smaller than maximum transmission power of another antenna, in the aspect 2.

According to the aforementioned configuration, the communication control device is able to cause the maximum transmission power of the antenna that is proximate to the user during usage to be smaller than maximum transmission power of another antenna, thus making it possible to suppress an influence of a radio wave output from an antenna on the user during usage. For example, in a case where the SAR is taken into account, an influence of the SAR on the user is able to be suppressed.

The communication control device (30) according to an aspect 4 of the invention may further include a radio wave state determination unit (31) that determines a radio wave state from a base station, and may have a configuration in which the use antenna decision unit (33) switches the use antennas (11a to 11f) in accordance with the radio wave state, and the transmission power decision unit (34) decides maximum transmission power for each of antennas that are switched on, in the any of the aspects 1 to 3.

According to the aforementioned configuration, the communication control device is able to switch the use antennas in accordance with the radio wave state from the base station and provide maximum transmission power corresponding to the use antenna that is switched on.

The communication control device (30) according to an aspect 5 of the invention may further include: a sensor (14) that acquires a gripping state of the communication terminal (smartphone 1); and a gripping state evaluating unit (32) that evaluates the gripping state of the communication terminal by the user in accordance with an output of the sensor, and may have a configuration in which the use antenna decision unit (33) switches the use antennas (11a to 11f) in accordance with the gripping state, and the transmission power decision unit (34) decides maximum transmission power for each of the antennas that are switched on, in the any of the aspects 1 to 4.

According to the aforementioned configuration, the communication control device is able to switch use antennas in accordance with the gripping state of the user and provide maximum transmission power corresponding to the use antenna that is switched on.

A communication terminal (smartphone 1) according to an aspect 6 of the invention may have a configuration of including the communication control device (30) according to any one of the aspects 1 to 5.

According to the aforementioned configuration, the communication terminal exerts an action effect similar to that of the communication control device according to the aspect 1.

A method for controlling a communication terminal (smartphone 1) according to an aspect 7 of the invention is a method for controlling a communication terminal that includes a plurality of antennas (11a to 11f) and performs communication by a communication system by which communication is performed by using a plurality of bands at a same time and by which a total sum of maximum transmission power of the plurality of antennas falls within a specified value, and includes: a use antenna decision step (S2) of deciding one or more antennas used for communication from among the plurality of antennas in accordance with a use band; and a transmission power decision step (S3) of, in a case where a plurality of antennas are used, deciding maximum transmission power for each of the use antennas in accordance with a position-characteristic relationship that is a relationship between a position of the antenna in the communication terminal and an antenna characteristic of the antenna.

According to the aforementioned configuration, an action effect similar to that of the aspect 1 is exerted.

A communication terminal according to an aspect 8 of the invention is a communication terminal that includes a plurality of antennas and a communication control device, and performs communication by a communication system by which communication is performed by using a plurality of bands at a same time and by which a total sum of maximum transmission power of the plurality of antennas falls within a specified value, and has a configuration in which the communication control device performs processing of deciding one or more antennas used for communication from among the plurality of antennas in accordance with a use band; and processing of, in a case where a plurality of antennas are used, deciding maximum transmission power for each of the use antennas in accordance with a position-characteristic relationship that is a relationship between a position of the antenna in the communication terminal and an antenna characteristic of the antenna.

According to the aforementioned configuration, an action effect similar to that of the aspect 1 is exerted.

The communication control device according to each aspect of the invention may be realized by a computer, and in such a case, a control program for the communication control device that realizes the communication control device by a computer by causing the computer to operate as each unit (software element) of the communication control device, and a computer-readable storage medium having the control program stored therein are also included in the scope of the invention.

The invention is not limited to each of the embodiments described above, and may be modified in various manners within the scope indicated in the claims and an embodiment achieved by appropriately combining technical means disclosed in different embodiments is also encompassed in the technical scope of the invention.

### REFERENCE SIGNS LIST

1 smartphone (communication terminal)
11a to 11f antenna
12, 12a and 12b antenna switch
13a to 13c transmission circuit
14 sensor
20 storage unit
21 maximum transmission power table
30 communication control device
31 radio wave state determination unit
32 gripping state determination unit
33 use antenna decision unit
34 transmission power decision unit

1. A communication control device of a communication terminal, the communication terminal including a plurality of antennas and performing communication by a communication system by which communication is performed by using a plurality of bands at a same time and by which a total sum of maximum transmission power of the plurality of antennas falls within a specified value, the communication control device comprising:
a use antenna decision unit that decides one or more antennas used for communication from among the plurality of antennas in accordance with a use band; and
a transmission power decision unit that, in a case where a plurality of antennas are used, decides maximum transmission power for each of the use antennas in accordance with a position-characteristic relationship that is a relationship between a position of the antenna in the communication terminal and an antenna characteristic of the antenna.

2. The communication control device according to claim 1, wherein
the position-characteristic relationship is defined on a basis of a positional relationship between a user and the antenna when the communication terminal is used.

3. The communication control device according to claim 2, wherein
the transmission power decision unit causes maximum transmission power of an antenna that is proximate to the user when the communication terminal is used among the plurality of antennas to be smaller than maximum transmission power of another antenna.

4. The communication control device according to claim 1, further comprising
a radio wave state determination unit that determines a radio wave state from a base station, wherein
the use antenna decision unit switches the use antennas in accordance with the radio wave state, and
the transmission power decision unit decides maximum transmission power for each of antennas that are switched on.

5. The communication control device according to claim 1, further comprising:
a sensor that acquires a gripping state of the communication terminal; and
a gripping state evaluating unit that evaluates the gripping state of the communication terminal by the user in accordance with an output of the sensor, wherein
the use antenna decision unit switches the use antennas in accordance with the gripping state, and
the transmission power decision unit decides maximum transmission power for each of the antennas that are switched on.

6. A communication terminal comprising the communication control device according to claim 1.

7. A method for controlling a communication terminal that includes a plurality of antennas and performs communication by a communication system by which communication is performed by using a plurality of bands at a same time and by which a total sum of maximum transmission power of the plurality of antennas falls within a specified value, the method comprising:
a use antenna decision step of deciding one or more antennas used for communication from among the plurality of antennas in accordance with a use band; and
a transmission power decision step of, in a case where a plurality of antennas are used, deciding maximum transmission power for each of the use antennas in accordance with a position-characteristic relationship that is a relationship between a position of the antenna in the communication terminal and an antenna characteristic of the antenna.

8. (canceled)

9. (canceled)

10. A communication terminal that includes a plurality of antennas and a communication control device, and performs communication by a communication system by which communication is performed by using a plurality of bands at a same time and by which a total sum of maximum transmission power of the plurality of antennas falls within a specified value, wherein
the communication control device performs
processing of deciding one or more antennas used for communication from among the plurality of antennas in accordance with a use band; and
processing of, in a case where a plurality of antennas are used, deciding maximum transmission power for each of the use antennas in accordance with a position-characteristic relationship that is a relationship between a position of the antenna in the communication terminal and an antenna characteristic of the antenna.
